(19) United States
(12) Patent Application Publication
(10) Pub. No.: US 2006/0164011 A1
(43) Pub. Date: Jul. 27, 2006

(54) Photosensitive paste composition, PDP electrode manufactured using the composition, and PDP including the PDP electrode

(76) Inventors: Beom-Wook Lee, Suwon-si (KR); Jong-Seo Choi, Suwon-si (KR)

Correspondence Address: Robert E. Bushnell, Suite 300, 1522 K Street, N.W., Washington, DC, 20005, US

(21) Appl. No.: 11/324,807

(22) Filed: Jan. 4, 2006

(30) Foreign Application Priority Data
Jan. 5, 2005 (KR) 10-2005-0000791

(51) Int. Cl. H01J 17/49

(52) U.S. Cl. 313/582

(57) ABSTRACT

A plasma display panel (PDP) electrode contains a superconductor and an inorganic binder. A photosensitive paste composition for manufacturing the PDP electrode contains a superconductor, an inorganic binder, and a photosensitive vehicle. In the photosensitive paste composition, a superconductor with excellent conductivity is used as a black pigment, so that the discharge voltage is low, the resistance is uniform, and a difference in brightness between electrodes is minimized in double layer bus electrodes manufactured using the composition. In addition, single layer bus electrodes with high conductivity and degree of blackness can be manufactured using the photosensitive composition. With the use of the plasma display panel electrode, the improved plasma display panel is provided.

### CROSS-REFERENCE TO RELATED PATENT APPLICATION AND CLAIM OF PRIORITY

This application claims the benefit of Korean Patent Application No. 10-2005-0000791, filed on Jan. 5, 2005, in the Korean Intellectual Property Office, the disclosure of which is incorporated herein in its entirety by reference.

### BACKGROUND OF THE INVENTION

1. Field of the Invention

The present invention relates to a plasma display panel (PDP) electrode, and a photosensitive paste composition for forming the PDP electrode, and more particularly, to a PDP electrode containing a superconductor having a high degree of blackness and high conductivity as a black layer in a single layer bus electrode structure or a double layer bus electrode structure.

2. Description of the Related Art

A bus electrode in a plasma display panel includes a black layer and a white conductive layer. The black layer for improving the contrast is composed of glass frit and a black pigment. The conductive layer is composed of a conductive metal with high electrical conductivity and glass frit. Such a double layer bus electrode is used because a single layer bus electrode cannot satisfy the requirements for both contrast and electrical conductivity. In particular, a single layer bus electrode is composed of a black pigment, conductive metal, and glass frit. In the single layer bus electrode, when the amount of the black pigment, which is a non-conductive material, is increased to obtain a high degree of blackness, the resistance of the bus electrode increases and the electrical conductivity decreases. When the amount of the conductive metal material is increased to improve electrical conductivity, the degree of blackness decreases. For these reasons, bus electrodes for PDPs are formed as double layers even though their manufacturing process is complicated. In double layer bus electrodes, their white conductive layer functions as an electrode and can increase the brightness by reflecting visible light emitted from phosphor in a rear panel.

However, in such double layer bus electrodes, a discharge voltage increases due to a large difference in electrical resistance between the non-conductive black layer and the conductive layer, and the conductivities of the bus electrodes are not uniform, thereby resulting in a difference in brightness. To solve these problems, Korean Patent No. 10-0392867 discloses the use of a black conductive metal oxide instead of a non-conductive black pigment. U.S. Pat. No. 6,555,594 entitled Photo-curable electrically conductive composition and plasma display panel having electrodes formed by use of the same to Fukushima et al. discloses the particlization of black pigment. However, there is a limit to the improvement in the conductivity of electrodes attainable with current black pigments.

### SUMMARY OF THE INVENTION

The present invention provides a black electrode for plasma display panels (PDPs) that has a high degree of blackness and high conductivity, a photosensitive paste composition used for manufacturing the black electrode, and a PDP including the black electrode.

According to an aspect of the present invention, there is provided a PDP electrode containing a superconductor, a conductive powder, and an inorganic binder.

According to another aspect of the present invention, there is provided a photosensitive paste composition for manufacturing a PDP electrode, the photosensitive paste composition comprising a superconductor, a conductive powder, an inorganic binder, and a photosensitive vehicle containing an organic binder, a cross-linking agent, a photoinitiator, and a solvent.

According to another aspect of the present invention, there is provided a PDP including the above-described PDP electrode.

### BRIEF DESCRIPTION OF THE DRAWINGS

A more complete appreciation of the present invention, and many of the above and other features and advantages of the present invention, will be readily apparent as the same becomes better understood by reference to the following detailed description when considered in conjunction with the accompanying drawings in which like reference symbols indicate the same or similar components, wherein:

FIG. 1 illustrates a sectional structure of a front panel of a plasma display with double layer bus electrodes;

FIG. 2 is a sectional view illustrating a basic cell structure of a plasma display panel (PDP); and

FIG. 3 is a partially cut-away perspective view of a PDP including a PDP electrode manufactured according to an embodiment of the present invention.

### DETAILED DESCRIPTION OF THE INVENTION

The present invention will be described in detail with reference to the appended drawings.

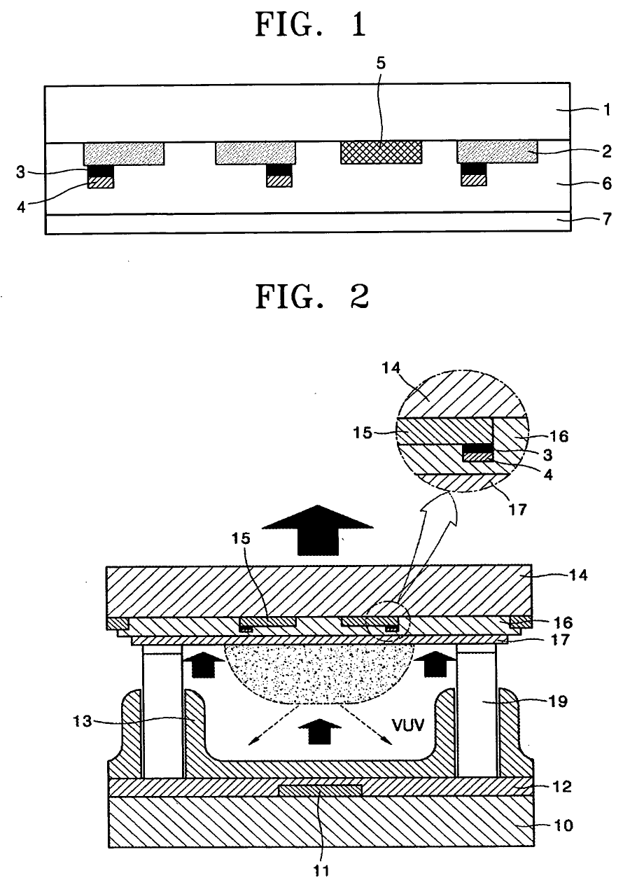

For the general concept of the PDP structure, FIG. 1 illustrates a sectional structure of an upper panel of a PDP. Transparent electrodes 2 and black stripes 5 are formed on a rear surface of a substrate 1. A bus electrode is formed on a region of each of the transparent electrodes 2, and a dielectric layer 6 having insulating properties is formed on the bus electrode. A protective layer 7 is formed to protect the dielectric layer 6. The bus electrode includes a black layer 3 and a white conductive layer 4. The black layer 3 for improving the contrast is composed of glass frit and a black pigment. The conductive layer 4 is composed of a conductive metal with high electrical conductivity and glass frit. Such a double layer bus electrode is used because a single layer bus electrode cannot satisfy the requirements for both contrast and electrical conductivity. In particular, a single layer bus electrode is composed of a black pigment, conductive metal, and glass frit. In the single layer bus electrode, when the amount of the black pigment, which is a non-conductive material, is increased to obtain a high degree of blackness, the resistance of the bus electrode increases and the electrical conductivity decreases. When the amount of the conductive metal material is increased to improve electrical conductivity, the degree of blackness decreases. For these reasons, bus electrodes for PDPs are formed as double layers even though their manufacturing process is complicated. In double layer bus electrodes, their white conductive layer functions as an electrode and can increase the brightness by reflecting visible light emitted from phosphor in a rear panel.

However, in such double layer bus electrodes, a discharge voltage increases due to a large difference in electrical resistance between the non-conductive black layer and the conductive layer, and the conductivities of the bus electrodes are not uniform, thereby resulting in a difference in brightness. To solve these problems, Korean Patent No. 10-0392867 discloses the use of a black conductive metal oxide instead of a non-conductive black pigment. U.S. Pat. No. 6,555,594 discloses the particlization of black pigment. However, there is a limit to the improvement in the conductivity of electrodes attainable with current black pigments.

The present invention provides a plasma display panel (PDP) electrode including a superconductor and an inorganic binder. The superconductor used as a black pigment in the present invention has higher electrical conductivity and a higher degree of blackness than ruthenium oxide or ruthenium composite oxide, which are highly conductive conventional black pigments.

When using such a superconductor to form a black layer of a double layer bus electrode, the electrical resistance of the black layer decreases, and thus the discharge voltage decreases. In addition, the conductivities of the bus electrodes are uniform, thereby minimizing a difference in brightness during light emission.

The superconductor is composed of a composite oxide of at least two elements selected from the group consisting of Y, La, Bi, Ti, Hg, Ba, Sr and Ca and Cu. Preferred examples of composite oxides include Y—Ba—Cu—O, Bi—Sr—Ca—Cu—O, Ti—Ba—Ca—Cu—O, Hg—Ba—Ca—Cu—O, La—Sr—Cu—O, La—Ba—Cu—O, etc. More preferred examples of composite oxides include YBa₂Cu₃O₇, Bi₂Sr₂CaCu₂O₈, HgBa₂Ca₂Cu₃O₈, La₂—XBa(Sr)XCuO₄, Ti₂Ba₂Ca₂Cu₃O₁₀, etc.

The term “superconductor” used throughout the specification means a material having superconductivity at an extremely low temperature of 30-130 K, not at room temperature, but having electrical conductivity that is several times greater than other black conductive metallic materials. The superconductors are preferably black due to copper oxide contained therein.

The particle shape of the superconductor is not limited, but is preferably spherical because spherical particles have higher filling ratio and higher UV transmission than flat or amorphous particles. The average particle diameter of the superconductor may be in a range of 0.1 to 10 μm. If the average particle diameter of the superconductor is less than 0.1 μm, the dispersibility decreases, and the printability deteriorates due to an increase in viscosity. If the average particle diameter of the superconductor is greater than 10 μm, the blackness decreases, and the linearity of electrode patterns deteriorates.

The amount of the superconductor in the PDP electrode may be in a range of 20 to 120 parts by weight based on 100 parts by weight of an inorganic binder in the composition for forming a black layer of the double layer bus electrode. If the amount of the superconductor is less than 20 parts by weight, the degree of blackness of the composition for forming the double layer bus electrode becomes too low to improve the contrast. If the amount of the superconductor is greater than 120 parts by weight, the amount of the inorganic binder in the composition for the double layer electrode is insufficient to obtain a desired electrode shape.

The superconductor can be used to form a single layer bus electrode satisfying the requirements for high electrical conductivity and high degree of blackness due to the excellent electrical conductivity and high degree of blackness of the superconductor. Therefore, in an embodiment of the present invention, the black layer 3 and the white conductive layer 4, which form the bus electrodes in FIG. 1, may be formed as a single layer.

A composition for forming such a single layer bus electrode may further contain conductive powder. The amount of the conductive powder is in a range of 200 to 2,000 parts by weight based on 100 parts by weight of the superconductor. If the amount of the conductive powder is less than 200 parts by weight, the resistance of the single layer bus electrodes increases, causing a short-circuit. If the amount of the conductive powder is greater than 2000 parts by weight, a desired degree of blackness cannot be obtained.

The conductive powder may be composed of Ag, Au, Cu, Pt, Pd, Al, Ni, or an alloy of the forgoing elements, and Ag is preferred. The particle shape of the conductive powder may be spherical. Spherical particles are advantageous in filling ratio and UV transmittance over flat or amorphous particles. The average particle diameter of the conductive powder may be in a range of 1.0 to 5.0 μm. If the average particle diameter of the conductive powder is larger than 5.0 μm the linearity of calcinated layer patterns deteriorates, and the density of the calcinated layer decreases, thereby increasing the resistance. If the average particle diameter of the conductive powder is less than 1.0 μm, the dispersibility of the paste composition deteriorates, and the exposure sensitivity decreases.

The composition for forming the double layer or single layer bus electrode may further contain nanoparticles having nano-scale average diameters. Due to the addition of a small amount of nanoparticles, the amount of an organic solid content can be reduced, thereby minimizing the shrinkage ratio during calcination. Therefore, an edge curling that occurs at the pattern edges due to a difference in shrinkage ratio after calcination is minimized, improving withhold voltage characteristics.

The nanoparticles may be composed of Ag, Au, Cu, Pt, Pd, Al, Ni, W, Mo, or an alloy of these materials, silica, alumina, or inorganic binder, which are nonconductive or weakly conductive, or at least one superconductor suggested in the present invention. Especially, when a superconductor is used for the nanoparticles, the superconductor can improve the degree of blackness. The nanoparticles may be the same as or may differ from the conductive powder. The shapes of the nanoparticles are determined in consideration of specific surface area, UV transmittance, etc. The shapes of the nanoparticles may be spherical. The average particle diameter of the nanoparticles may be in a range of 1 to 100 nm. If the average particle diameter of the nanoparticles is greater than 100 nm, the effect of increasing the viscosity of the paste composition is trivial. If the average particle diameter of the nanoparticles is less than 1 nm, the dispersibility and viscosity of the paste composition increases too fast to be controlled. The amount of the nanoparticles in the paste composition may be in a range of 0.1 to 10.0% by weight based on the total weight of the paste composition. If the amount of the nanoparticles is less than 0.1% by weight, the viscosity of the paste composition is too high, so that the printability and the exposure sensitivity deteriorate.

A PDP electrode according to an embodiment of the present invention includes an inorganic binder. The inorganic binder improves the sintering characteristics of the conductive powder during calcination and provides the adhesion between the conductive powder and a glass substrate. Examples of the inorganic binder include composite oxides of Pb, Si, B, Al, Zn, Na, K, Mg, Ba, and Bi. The inorganic binder may be at least one selected from the group consisting of, but not limited to, PbO—SiO₂, PbO—SiO₂—B₂O₃, PbO—SiO₂—B₂O₃—ZnO, PbO—SiO₂—B₂O₃—BaO, PbO—SiO₂—ZnO—BaO, ZnO—SiO₂, ZnO—B₂O₃—SiO₂, ZnO—K₂O—B₂O₃—SiO₂—BaO, Bi₂O₃—SiO₂, Bi₂O₃—B₂O₃—SiO₂, Bi₂O₃—B₂O₃—SiO₂—BaO, and Bi₂O₃—B₂O₃—SiO₂—BaO—ZnO. The particle shape of the inorganic binder is not limited. However, the particle shape of the inorganic binder may be spherical. The average particle diameter of the inorganic binder may be 5.0 μm or less, preferably 1.0 to 5.0 μm. If the average particle diameter of the inorganic binder is greater than 5 μm, the calcinated layer is non-uniform, and the linearity of the electrode deteriorates.

The softening temperature of the inorganic binder may be in a range of 400 to 600° C. If the softening temperature of the inorganic binder is lower than 400° C., the inorganic binder flows out through the periphery of the electrode or inhibit the decomposition of organic substance. If the softening temperature of the inorganic binder is higher than 600° C., the glass substrate bends and cannot be used any longer. In the composition for forming the black layer of the double layer bus electrode, the amount of the inorganic binder may be in a range of 80 to 500 parts by weight based on 100 parts by weight of the conductive powder. In the composition for forming the single layer bus electrode, the amount of the inorganic binder may be in a range of 1 to 10 parts by weight based on 100 parts by weight of the conductive powder. If the amount of the inorganic binder is less than the above ranges, the adhesion of the double layer and the single layer decreases. If the amount of the inorganic binder is greater than the above ranges, the degree of blackness in the double layer decreases, and the resistance of the electrode in the single layer increases.

FIG. 2 is a sectional view illustrating a basic cell structure of a PDP. A front panel includes a front substrate 14, a front dielectric layer including transparent electrodes 15 formed on a rear surface of the front substrate 14, and a protective layer 17 covering the front dielectric layer 16. Each of the transparent electrodes 15 includes a black layer 3 for improving the contrast and a conductive layer 4 providing conductivity, which form bus electrodes. The conductive layer 4 functions as an electrode and also increases the brightness by reflecting visible light emitted from a phosphor layer 13 on a rear panel. The rear panel includes a rear substrate 10, address electrodes 11 formed on a front surface of the rear substrate 10 to form a matrix with the transparent electrodes 15, a rear dielectric layer 12 covering the address electrodes 11, barrier ribs 19 formed between the protective layer 17 and the rear dielectric layer 12 to define cells, and a phosphor layer 13. Although the double layer electrodes are illustrated in FIG. 2, as described above, single layer bus electrodes in which the black layer 3 and the conductive layer 4 are formed as a single layer may be implemented according to the present invention.

The present invention also provides a photosensitive phase composition for forming PDP electrodes that contains a superconductor, an inorganic binder, and a photosensitive vehicle.

Details on the superconductor and the inorganic binder are the same as described above.

The photosensitive vehicle includes an organic binder, a cross-linking agent, a photoinitiator, a solvent, and other additives. The amount of the photosensitive vehicle may be in a range of 10 to 50 parts by weight based on 100 parts by weight of the photosensitive paste composition for a double layer bus electrode or for a single layer bus electrode. If the amount of the photosensitive vehicle is less than 10 parts by weight, the printability and exposure sensitivity of the paste composition deteriorate. If the amount of the photosensitive vehicle is greater than 50 parts by weight, the amount of inorganic components is relatively reduced so that bus electrodes with a desired shape cannot be obtained.

The amount of the organic binder in the photosensitive vehicle may be in a range of 10 to 50 parts by weight based on 100 parts by weight of the photosensitive vehicle. The other additives in the photosensitive vehicle may include a cross-linking agent in an amount of 20 to 150 parts by weight, a photoinitiator in an amount of 10 to 150 parts by weight, and a solvent in an amount of 100 to 500 parts by weight, based on 100 parts by weight of the organic binder.

When an aqueous alkali solution is used as an alkaline solution in a developing process, an organic binder having an acidic group is used. Various kinds of polymers can be used as such an organic binder. Acrylic resin is most suitable among various kinds of polymers in view of costs. Monomers having carboxyl groups can be used to add acidic groups into acrylic resin. Therefore, according to the present invention, a copolymer of a monomer having a carboxyl group and at least one different monomer can be used as the organic binder. Any monomer having a carboxyl group can be used without limitation. However, preferred monomer having carboxyl groups include an acrylic acid, a methacrylic acid, a fumaric acid, a maleic acid, a vinylacetic acid, and an anhydride thereof. The other monomer to be copolymerized with such a monomer having a carboxyl group may be at least one selected from the group consisting of methylacrylate, methylmethacrylate, ethylacrylate, ethylmethacrylate, n-butylacrylate, n-butylmethacrylate, isobutylacrylate, isobutylmethacrylate, 2-hydroxyethylacrylate, 2-hydroxyethylmethacrylate, ethyleneglycolmonomethyletheracrylate, ethyleneglycolmonomethylethermethacrylate, styrene, and p-hydroxystyrene.

The organic binder which is formed of the copolymer of the monomer having a carboxyl group and the other monomer may be further copolymerized with an ethylenically unsaturated monomer. A cross-linkable group which can induce a cross-linking reaction between a monomer having a carboxyl group and an ethylenically unsaturated monomer may be further added to the organic binder. The ethylenically unsaturated monomer may be at least one selected from the group consisting of glycidylmethacrylate, 3,4-epoxycyclohexylmethylmethacrylate, and 3,4-epoxycyclohexylmethylacrylate.

The copolymer can be used alone as the organic binder. However, for the purpose of enhancing the film leveling property or thixotropic property, a mixture of the copolymer with at least one selected from the group consisting of methylcellulose, ethylcellulose, nitrocellulose, hydroxymethylcellulose, hydroxyethylcellulose, hydroxypropylcellulose, carboxymethylcellulose, carboxyethylcellulose, and carboxyethylmethylcellulose can also be used.

The copolymer may have a molecular weight in a range of 5,000 to 100,000 g/mol and an acid value of 20 to 150 mgKOH/g. If the molecular weight of the copolymer is less than 5,000 g/mol, the printability of the paste deteriorates. If the molecular weight of the copolymer is greater than 100,000 g/mol, an unexposed region may not be removed during a developing process. If the acid value of the copolymer is less than 20 mgKOH/g, the developing property deteriorates. If the acid value of the copolymer is larger than 150 mgKOH/g, even an exposed region may be developed.

The cross-linking agent used in the photosensitive vehicle may be a monofunctional or multifunctional monomer. In general, the multifunctional monomer may be, but not limited to, at least one selected from the group consisting of diacrylates, such as ethylene glycol diacrylate (EGDA); triacrylates, such as trimethylolpropane triacrylate (TMPTA), trimethylolpropaneethoxylatetriacrylate (TMPEOTA), or pentaerythritoltriacrylate (PETA); tetraacrylates, such as tetramethylolpropanetetraacrylate or pentaerythritoltetraacrylate; and hexaacrylates, such as dipentaerythritolhexaacrylate (DPHA).

The amount of the cross-linking agent may be in a range of 20 to 150 parts by weight based on 100 parts by weight of the copolymer organic binder. If the amount of the cross-linking agent is less than 20 parts by weight, the exposure sensitivity decreases, and a calcinated layer with a desired linewidth cannot be obtained. If the amount of the cross-linking agent is greater than 150 parts by weight, undesirably a calcinated layer produces residues.

The photoinitiator used in the photosensitive vehicle may be, but not limited to, at least one selected from the group consisting of benzophenone, o-benzoylbenzoic acid methyl, 4,4-bis(dimethylamine)benzophenone, 4,4-bis(diethylamino)benzophenone, 2,2-diethoxyacetophenone, 2,2-dimethoxy-2-phenyl-2-phenylacetophenone, 2-methyl-[4-(methylthio)phenyl]-2-morpholinopropane-1 -one, 2-benzyl-2-dimethylamino-1-(4-morpholinophenyl)-1-butanone, bis(2,6-dimethoxybenzoyl)-2,4,4-trimethylpentylphosphineoxide, and bis(2,4,6-trimethylbenozyl)phenylphosphineoxide. The amount of the photoinitiator may be in a range of 5 to 100 parts by weight based on 100 parts by weight of the copolymer organic binder. If the amount of the photoinitiator is less than 5 parts by weight, the exposure sensitivity of a paste decreases, and a calcinated layer with a desired linewidth cannot be obtained. If the amount of the photoinitiator is greater than 100 parts by weight, the linewidth of a calcinated layer is too large, or developing cannot be performed.

The solvent used in the photosensitive vehicle may be a solvent capable of dissolving the binder and the photoinitiator and which is miscible with the cross-linking agent and other additives and has a boiling point of 150° C. or more. If the boiling point of the solvent is lower than 150° C., the solvent too easily vaporize during the preparation of the composition, in particular during a three-roll mill process, thereby resulting in low print quality. Furthermore, the solvent may be easily evaporated upon printing, thereby lowering printability. A suitable solvent satisfying the above requirements may be, but not limited to, at least one selected from the group consisting of ethyl carbitol, butyl carbitol, ethyl carbitol acetate, butyl carbitol acetate, texanol, terpene oil, dipropyleneglycolmethylether, dipropyleneglycolethylether, dipropyleneglycolmonomethyletheracetate, [symbol] -butyrolactone, cellosolve acetate, butylcellosolve acetate, and tripropyleneglycol. The amount of the solvent may be in a range of 100 to 500 parts by weight based on 100 parts by weight of the copolymer organic binder. If the amount of the solvent is less than 100 parts by weight, the viscosity of the paste is too high to allow smooth printing. If the amount of the solvent is greater than 500 parts by weight, the viscosity of the paste is too low to perform printing.

The photosensitive vehicle may further include an additive, such as a sensitizer for enhancing sensitivity, a polymerization inhibitor and an antioxidant, which enhances the storage stability of the composition, a UV absorbent, which improves the resolution, an antifoaming agent, which reduces bubbles in the composition, a dispersing agent, which improves the dispersibility, a leveling agent, which improves the flatness of the layer during printing, and a plasticizer, which improves the printability. These additives are optionally, not necessarily, used. Such additives increase the thickness of a dried layer and may be used in minimal amounts.

The photosensitive paste composition according to an embodiment of the present invention can be prepared according to the following method. Initially, a photosensitive vehicle is prepared by mixing and stirring an organic binder, a cross-linking agent, a photoinitiator, a solvent, and other additives. Next, a superconductor and inorganic binder according to the present invention are put into a mixer, such as a planetary mixer (PLM), and the prepared photosensitive vehicle is slowly added into the mixture while stirring. A resulting mixed paste is mechanically mixed using a 3-roll mill. Impurities, such as particles having large particle diameters, dust, etc., are removed through filtering, and bubbles are removed from the paste using a debubbling apparatus, thereby resulting in the photosensitive paste composition according to the present invention.

### Method of Manufacturing Double Layer Bus Electrodes

A photosensitive paste for forming a black layer is coated on the entire surface of a front substrate of a PDP on which an ITO transparent electrode pattern is formed, with a screen mask, such as SUS 325 mesh, SUS 400 mesh, etc., on the front substrate using a screen printer and dried in a convection oven or an IR oven at a temperature of 80 to 150° C. for 5 to 30 minutes to form the black layer. A photosensitive paste for forming a conductive layer is coated on the entire surface of the dried black layer, with a screen mask, such as SUS 325 mesh, SUS 400 mesh, etc., thereon using a screen printer and dried in a convention oven or an IR oven at a temperature of 80 to 150° C. for 5 to 30 minutes to form the conductive layer. The resulting double layer paste coated layer is exposed to light having a wavelength of 300 to 450 nm using a UV light source to form a pattern and developed using an appropriate alkali solution, such as Na₂CO₃, KOH, TMAH, etc. at about 30° C. to remove an unexposed portion, resulting in a fine pattern in the double layer.

The double layer with the fine pattern is calcinated in, for example, an electric furnace, at 500 to 600° C. for 10 to 30 minutes to thereby complete double layer bus electrodes.

### Method of Manufacturing Single Layer Bus Electrodes

A photosensitive paste for forming a single layer bus electrode is coated on the entire surface of a front substrate of a PDP on which an ITO transparent electrode pattern is formed, with a screen mask, such as SUS 325 mesh, SUS 400 mesh, etc., on the front substrate using a screen printer and dried in a convection oven or an IR oven at a temperature of 80 to 150° C. for 5 to 30 minutes. The resulting paste coated layer is exposed to light having a wavelength of 300 to 450 nm using a UV light source to form a pattern and developed using an appropriate alkali solution, such as Na₂CO₃, KOH, TMAH, etc. at about 30° C. to remove an unexposed portion, resulting in a fine pattern in the layer. The layer with the fine pattern is calcinated in, for example, an electric furnace, at 500 to 600° C. for 10 to 30 minutes to thereby complete single layer bus electrodes.

When using a photosensitive green sheet, to form bus electrodes instead of the above-described method, the above-described method is performed in the same manner as described above, except that coating is performed using a laminator, instead of screen printing, to form a fine pattern. The resulting layer with the fine pattern is calcinated, thereby completing the formation of the bus electrodes. The photosensitive green sheet can be manufactured using a photosensitive composition according to the following method.

### Method of Manufacturing a Photosensitive Green Sheet

A photosensitive paste is coated on a support film, such as a PET film, using a coater, etc., and dried in a convection oven or an IR oven at a temperature of 80 to 150° C. for 5 to 30 minutes to form a photosensitive layer. A PE film or the like is laminated on the photosensitive layer as a protective film.

The present invention also provides a PDP including the PDP electrodes manufactured described above.

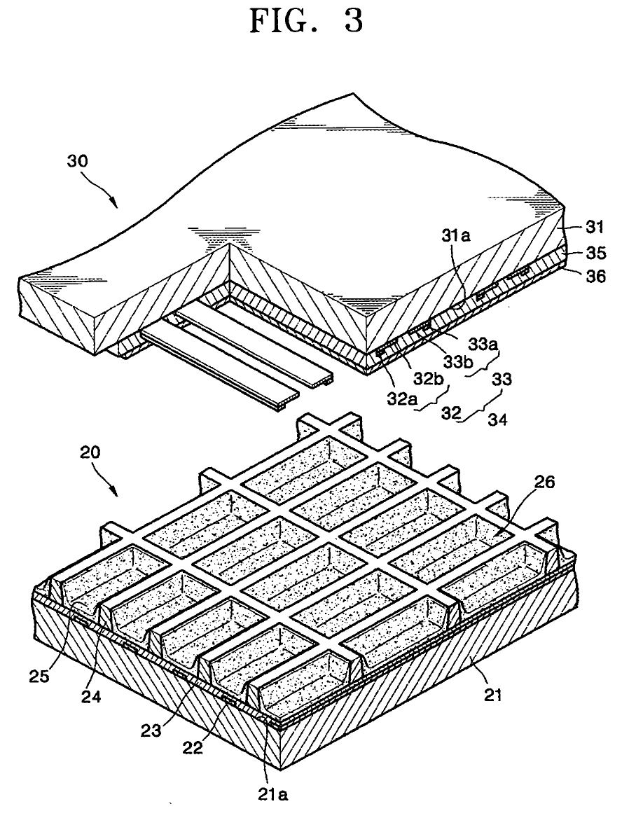

FIG. 3 illustrates a detailed structure of a PDP including the PDP electrodes according to the present invention. In the PDP structure described below, the photosensitive paste for forming the conductive layer according to the present invention that is used to form white bus electrodes can be also used to manufacture address electrodes.

A PDP manufactured according to the present invention has a structure including a front panel 30 and a rear panel 20. The front panel 30 includes a front substrate 31, sustain electrode pairs 34 formed on a rear surface 31a of the front substrate 31, each pair including a Y electrode 32 and an X electrode 33, a front dielectric layer 35 covering the sustain electrode pairs 34, and a protective layer 36 covering the front dielectric layer 35. The Y electrode 32 and the X electrode 33 respectively include transparent electrodes 32b and 33b formed of, for example, ITO, etc., and bus electrodes 32a and 33a, each including a black electrode (not shown) for improving the contrast and a white electrode (not shown) providing conductivity. The bus electrodes 32a and 33a are connected to connection cables arranged on the left and right sides of the PDP.

The rear panel 20 includes a rear substrate 21, address electrodes 22 formed on a front surface 21a of the rear substrate 21 to intersect the sustain electrode pairs 34, a rear dielectric layer 23 covering the address electrodes 22, barrier ribs 24 formed on the rear dielectric layer 23 to define luminescent cells 26, and a phosphor layer 25 arranged in the luminescent cells 26. The address electrodes 22 are connected to connection cables arranged on upper and lower sides of the PDP.

Hereinafter, the present invention will be described more specifically with reference to the following examples. The following examples are for illustrative purposes and are not intended to limit the scope of the invention.

### EXAMPLES

### Example 1

### Preparation of Photosensitive Paste Composition for Forming Black Layer of Double Layer Bus Electrode

1) Preparation of Composition 1

Paste components, i.e., 25 wt % of a black pigment (YBa₂Cu₃O₇, average particle diameter=1.5 μm, amorphous), 37.0 wt % of glass frit (average particle diameter=2.1 μm, amorphous, PbO—SiO₂—B₂O₃), 6.0 wt % of binder 1 (poly(MMA-co-MM) copolymer, molecular weight=15,000 g/mol, acid value=105 mgKOH/g), 1.0 wt % of binder 2 (hydroxypropyl cellulose, average molecular weight (Mw)=100,000 g/mol), 1.0 wt % of photoinitiator 1 (2-methyl-1-[4-(methylthio)phenyl]-2-morpholinopropane-1-one), 0.3 wt % of photoinitiator 2 (2,4-diethylthioxantone), 4.0 wt % of cross-linking agent 1 (trimethyolpropane ethoxylate triacrylate), 2.0 wt % of cross-linking agent 2 (dipentaerythritolhexaacrylate), and 23.7 wt % of a solvent (texanol) were mixed, stirred with a stirrer, and kneaded in a three-roll mill to prepare a photosensitive paste composition according to the present invention. In the preparation of the photosensitive paste composition, a photosensitive vehicle was initially prepared, and then the glass frit was added to the photosensitive vehicle.

2) Preparation of Composition 2

Composition 2 was prepared in the same manner as in the preparation of composition 1, except that Bi₂Sr₂CaCu₂O₈ (average particle diameter=1.2 μm, amorphous) was used as the black pigment.

3) Preparation of Comparative Composition 1

Comparative composition 1 was prepared in the same manner as in the preparation of composition 1, except that a Co—Mn—Fe oxide (average particle diameter=1.4 μm, amorphous) was used as the black pigment.

### Example 2

### Preparation of Photosensitive Paste Composition for Forming Single Layer Bus Electrodes

1) Preparation of Composition 3

Paste components, i.e., 12 wt % of a black pigment (YBa₂Cu₃O₇, average particle diameter=0.4 μm, amorphous), 60 wt % of conductive powder (Ag powder, average particle diameter=1.3 μm), 2.0 wt % of glass frit (average particle diameter=2.1 μm, amorphous, PbO—SiO₂—B₂O₃), 6.0 wt % of binder 1 (poly(MMA-co-MM) copolymer, molecular weight=15,000 g/mol, acid value=105 mgKOH/g), 1.0 wt % of binder 2 (hydroxypropyl cellulose, average molecular weight (Mw)=100,000 g/mol), 1.0 wt % of photoinitiator (2-methyl-1-[4-(methylthio)phenyl]-2-morpholinopropane-1-one), 0.3 wt % of photoinitiator 2 (2,4-diethylthioxantone), 4.0 wt % of cross-linking agent 1 (trimethyolpropane ethoxylate triacrylate), 2.0 wt % of cross-linking agent 2 (dipentaerythritolhexaacrylate), and 11.7 wt % of a solvent (texanol) were mixed, stirred with a stirrer, and kneaded in a three-roll mill to prepare a photosensitive paste composition according to the present invention. In the preparation of the photosensitive paste composition, a photosensitive vehicle was initially prepared, and then the glass frit was added to the photosensitive vehicle.

2) Preparation of Composition 4

Composition 4 was prepared in the same manner as in the preparation of composition 3, except that Ti₂Ba₂Ca₂Cu₃O₁₀ (average particle diameter=0.5 μm, amorphous) was used as the black pigment.

3) Preparation of Comparative Composition 2

Comparative composition 2 was prepared in the same manner as in the preparation of Composition 3, except that a Co—Mn—Fe oxide (average particle diameter=0.5 μm, amorphous) was used.

### Example 3

### Preparation of Photosensitive Paste Composition for Forming Conductive Layer of Double Layer Bus Electrode

1) Preparation of Composition 5

Paste components, i.e., 65 wt % of conductive powder (Ag powder, average particle diameter=1.5 μm), 3.0 wt % of glass frit (average particle diameter=2.1 μm, amorphous, PbO—SiO₂—B₂O₃), 6.0 wt % of binder 1 (poly(MMA-co-MM) copolymer, molecular weight=15,000 g/mol, acid value=105 mgKOH/g), 1.0 wt % of binder 2 (hydroxypropyl cellulose, average molecular weight (Mw)=100,000 g/mol), 1.0 wt % of photoinitiator 1 (2-methyl-1-[4-(methylthio)phenyl]-2-morpholinopropane-1-one), 0.3 wt % of photoinitiator 2 (2,4-diethylthioxantone), 4.0 wt % of cross-linking agent 1 (trimethyolpropane ethoxylate triacrylate), 2.0 wt % of cross-linking agent 2 (dipentaerythritolhexaacrylate), and 17.7 wt % of a solvent (texanol) were mixed, stirred with a stirrer, and kneaded in a three-roll mill to prepare a photosensitive paste composition for forming conductive layers according to the present invention. In the preparation of the photosensitive paste composition, a photosensitive vehicle was initially prepared, and then the conductive powder and the glass frit were added to the photosensitive vehicle.

### Example 4

### Formation of Double Layer Bus Electrodes

Double layer bus electrodes were manufactured using each of compositions 1 and 2 and Comparative composition 1, which were photosensitive paste compositions for forming black layers, and composition 5, which as a photosensitive paste composition for forming conductive layers. The resistance and the blackness of the electrodes manufactured using each of the compositions were measured for comparison.

1) Using screen printing, each of Compositions 1 and 2 and Comparative composition 1 was coated on barrier ribs formed on a front substrate of a PDP on which ITO transparent patterns had been formed.

2) The paste coated layers were dried in an IR oven at 100° C. for 15 minutes.

3) Composition 5 was coated on each of the dried paste coated layers using screen printing.

4) The resultant structures were dried in an IR oven at 100° C. for 15 minutes.

5) The dried coated layers were exposed to UV light with an optical power of 400 mJ/cm² using a UV exposure system with a high-pressure mercury lamp.

6) The resultant structures were developed by spraying a 0.4% sodium carbonate solution at a nozzle pressure of 1.5 kgf/cm² and 35° C.

7) The resultant structures were calcinated in an electric furnace at 580° C. for 15 minutes to obtain double layer bus electrodes.

The results of evaluating double layer bus electrodes manufactured according to the above-described procedure are shown in Table 1.

TABLE 1

| | | | Comparative |
|---|---|---|---|
| Characteristic | Composition 1 | Composition 2 | composition 1 |
| Thickness of black | 1.5 | 1.4 | 1.5 |
| layer after | | | |
| calcination (μm) | | | |
| Thickness of | 3.8 | 3.7 | 3.9 |
| conductive layer | | | |
| after calcination | | | |
| (μm) | | | |
| Line resistance (Ω) | 32.5 | 34.2 | 47.1 |
| Color | Black | Black | Black |

As is apparent from the results in Table 1, the resistance was smaller when the superconductor was used as the black pigment than when the general black pigment was used. The colors of all the electrodes were black.

### Example 5

### Formation of Single Layer Bus Electrodes

Single layer bus electrodes were manufactured using each of compositions 3 and 4 and Comparative composition 2. The resistance and the blackness of the electrodes manufactured using each of the compositions were measured for comparison.

1) Using screen printing, each of Compositions 3 and 4 and Comparative composition 2 was coated on barrier ribs formed on a front substrate of a PDP on which ITO transparent patterns had been formed.

2) The paste coated layers were dried in an IR oven at 100° C. for 15 minutes.

3) The dried coated layers were exposed to UV light with an optical power of 500 mJ/cm² using a UV exposure system with a high-pressure mercury lamp.

4) The resultant structures were developed by spraying a 0.4% sodium carbonate solution at a nozzle pressure of 1.5 kgf/cm² and 35° C.

5) The resultant structures were calcinated in an electric furnace at 580° C. for 15 minutes to obtain single layer bus electrodes.

The results of evaluating single layer bus electrodes manufactured according to the above-described procedure are shown in Table 1.

TABLE 2

| | | | Comparative |
|---|---|---|---|
| Characteristic | Composition 3 | Composition 4 | composition 2 |
| Thickness after | 4.5 | 4.4 | 4.4 |
| calcination (μm) | | | |
| Line resistance (Ω) | 46.5 | 47.3 | 60.4 |
| Color | Black | Black | Black |

As is apparent from the results in Table 2, the resistance was smaller when the superconductor was used as the black pigment than when the general black pigment was used. The colors of all the electrodes were black.

As described above, in a photosensitive paste composition for forming double layer bus electrodes of PDPs according to the present invention, a superconductor with excellent conductivity is used as a black pigment, so that the discharge voltage is low, the resistance is uniform, and a difference in brightness between electrodes is minimized. In addition, single layer bus electrodes with high conductivity and degree of blackness can be manufactured using the photosensitive composition.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A plasma display panel electrode, comprising:
a superconductor;
an inorganic binder; and
a conductive powder.

2. The plasma display panel electrode of claim 1, wherein the superconductor is a composite oxide of at least two elements selected from the group consisting of Y, La, Bi, Ti, Hg, Ba, Sr and Ca, and Cu.

3. The plasma display panel electrode of claim 1, wherein the super conductor is a composite oxide selected from the group consisting of Y—Ba—Cu—O, Bi—Sr—Ca—Cu—O, Ti—Ba—Ca—Cu—O, Hg—Ba—Ca—Cu—O, La—Sr—Cu—O, and La—Ba—Cu—O.

4. The plasma display panel electrode of claim 1, wherein the superconductor is a composite oxide selected from the group consisting of YBa₂Cu₃O₇, Bi₂Sr₂CaCu₂O₈, HgBa₂Ca₂Cu₃O₈, La₂—XBa(Sr)XCuO₄, and Ti₂Ba₂Ca₂Cu₃O₁₀.

5. The plasma display panel electrode of claim 1, wherein the average particle diameter of the superconductor is in a range of 0.1 to 10 μm.

6. The plasma display panel electrode of claim 1, wherein the superconductor is a black superconductor.

7. The plasma display panel electrode of claim 6, which is formed of a black layer and a conductive layer, the black layer having the superconductor and the inorganic binder, the conductive layer having the conductive powder and the inorganic binder.

8. The plasma display panel electrode of claim 7, wherein the amount of the superconductor in the black layer is in a range of 20 to 120 parts by weight based on 100 parts by weight of the inorganic binder in the black layer.

9. The plasma display panel electrode of claim 1, which is made of a single layer.

10. The plasma display panel electrode of claim 9, wherein the amount of the conductive powder is in a range of 200 to 2,000 parts by weight based on 100 parts by weight of the superconductor, and the amount of the inorganic binder may be in a range of 1 to 10 parts by weight based on 100 parts by weight of the conductive powder.

11. The plasma display panel electrode of claim 9, wherein the conductive powder comprises Ag, Au, Cu, Pt, Pd, Al, Ni, or an alloy of the forgoing materials.

12. The plasma display panel electrode of claim 9, wherein the average particle diameter of the conductive power is in a range of 0.1 to 5.0 μm.

13. The plasma display panel electrode of claim 1, further comprises nanoparticles.

14. The plasma display panel electrode of claim 13, wherein the nanoparticles are composed of at least one selected from the group consisting of Ag, Au, Cu, Pt, Pd, Al, Ni, W, Mo, an alloy of the forgoing materials, silica, alumina, an inorganic binder, a superconductor, and the average particle diameter of the nanoparticles is in a range of 1 to 100 nm.

15. The plasma display panel electrode of claim 1, wherein the inorganic binder is a composite oxide of Pb, Si, B, Al, Zn, Na, K, Mg, Ba, or Bi.

16. The plasma display panel electrode of claim 1, wherein the inorganic binder is at least one selected from the group consisting of PbO—SiO₂, PbO—SiO₂—B₂O₃, PbO—SiO₂—B₂O₃—ZnO, PbO—SiO₂—B₂O₃—BaO, PbO—SiO₂—ZnO—BaO, ZnO—SiO₂, ZnO—B₂O₃—SiO₂, ZnO—K₂O—B₂O₃—SiO₂—BaO, Bi₂O₃—SiO₂, Bi₂O₃—B₂O₃—SiO₂, Bi₂O₃—B₂O₃—SiO₂—BaO, and Bi₂O₃—B₂O₃—SiO₂—BaO—ZnO.

17. The plasma display panel electrode of claim 1, wherein the softening temperature of the inorganic binder is in a range of 400 to 600° C., and the average particle diameter of the inorganic binder is 5 μm or less.

18. A plasma display panel comprising the plasma display panel electrode according to claim 1.

19. A photosensitive paste composition for forming a plasma display panel electrode, the composition comprising:
a superconductor;
an inorganic binder;
a conductive powder; and
a photosensitive vehicle containing an organic binder, a cross-linking agent, a photoinitiator, and a solvent.

20. The photosensitive paste composition of claim 19, wherein the photosensitive vehicle contains the cross-linking agent in an amount of 20 to 150 parts by weight, the photoinitiator in an amount of 10 to 150 parts by weight, and the solvent in an amount of 100 to 500 parts by weight, based on 100 parts by weight of the organic binder.

21. The photosensitive paste composition of claim 20, wherein the organic binder is a copolymer of a first monomer having a carboxyl group and at least one second monomer, the first monomer having the carboxyl group is at least one selected from the group consisting of an acrylic acid, a methacrylic acid, a fumaric acid, a maleic acid, a vinylacetic acid, and an anhydride of the forgoing acids, and the second monomer is at least one selected from the group consisting of methylacrylate, methylmethacrylate, ethylacrylate, ethylmethacrylate, n-butylacrylate, n-butylmethacrylate, isobutylacrylate, isobutylmethacrylate, 2-hydroxyethylacrylate, 2-hydroxyethylmethacrylate, ethyleneglycolmonomethyletheracrylate, ethyleneglycolmonomethylethermethacrylate, styrene, and p-hydroxystyrene.

22. The photosensitive paste composition of claim 21, wherein the copolymer includes a cross-linkable group derived through a reaction between the monomer having the carboxyl group and an ethylenically unsaturated monomer selected from the group consisting of glycidylmethacrylate, 3,4-epoxycyclohexylmethylmethacrylate, and 3,4-epoxycyclohexylmethylacrylate.

23. The photosensitive paste composition of claim 21, wherein the average molecular weight of the copolymer is in a range of 5,000 to 100,000 g/mol, and the acid value of the copolymer is in a range of 20 to 150 mgKOH/g.

24. The photosensitive paste composition of claim 19, wherein the cross-linking agent is at least one selected from the group consisting of diacrylates, triacrylates, tetraacrylates, and hexaacrylates.

25. The photosensitive paste composition of claim 19, wherein the solvent is at least one selected from the group consisting of ethyl carbitol, butyl carbitol, ethyl carbitol acetate, butyl carbitol acetate, texanol, terpene oil, dipropyleneglycolmethylether, dipropyleneglycolethylether, dipropyleneglycolmonomethyletheracetate, x -butyrolactone, cellosolve acetate, butylcellosolve acetate, and tripropyleneglycol.

26. The photosensitive paste composition of claim 19, wherein the photosensitive vehicle further comprises at least one additive selected from the group consisting of a sensitizer, a polymerization inhibitor, an antioxidant, a UV absorbent, an antifoaming agent, a dispersing agent, a leveling agent, and a plasticizer.

27. A photosensitive green sheet prepared using the photosensitive paste composition according to claim 19.

28. A plasma display panel, comprising:
a front panel comprising a front substrate, sustain electrode pairs formed on a rear surface of the front substrate, a front dielectric layer covering the sustain electrode pairs, and a protective layer covering the front dielectric layer, each sustain electrode pair including a Y electrode and an X electrode, each of the Y electrode and the X electrode comprising a transparent electrode and a bus electrode, the bus electrode comprising a superconductor, an inorganic binder and a conductive powder; and
a rear panel comprising a rear substrate, address electrodes formed on a front surface of the rear substrate to intersect the sustain electrode pairs, a rear dielectric layer covering the address electrodes, barrier ribs formed on the rear dielectric layer to define luminescent cells, and a phosphor layer arranged in the luminescent cells.

29. The plasma display panel of claim 28, wherein the bus electrode is formed of a single layer.

30. The plasma display panel of claim 28, wherein the bus electrode is formed of a double layer comprising a black layer having the superconductor and the inorganic binder and a conductive layer having the conductive powder and the inorganic binder.
